(19) United States
(12) Patent Application Publication
(10) Pub. No.: US 2018/0134307 A1
(43) Pub. Date: May 17, 2018

(54) STEERABLE JOGGING STROLLER

(71) Applicant: Baby Trend, Inc., Ontario, CA (US)

(72) Inventor: Mark Sedlack, Clinton, OH (US)

(73) Assignee: Baby Trend, Inc., Ontario, CA (US)

(21) Appl. No.: 15/810,293

(22) Filed: Nov. 13, 2017

Related U.S. Application Data
(60) Provisional application No. 62/420,917, filed on Nov. 11, 2016.

(51) Int. Cl. B62B 9/20; B62B 7/06; B62B 7/04

(52) U.S. Cl. CPC B62B 9/20; B62B 7/044; B62B 7/06

(57) ABSTRACT

A stroller, comprising: a support frame including a handle coupled through a pivot mechanism to a front fork attached to a front wheel, a pair of struts rotatably coupled to the pivot mechanism at one end and rotatably coupled to a pair of rear wheels at another end; wherein rotation of the handle to turn the stroller causes the front wheel and the pair of rear wheels to camber in a direction of rotation of the handle.

### CROSS-REFERENCE TO RELATED APPLICATIONS

The present application claims priority to U.S. Provisional Application Ser. 62/420,917, entitled “STEERABLE JOGGING STROLLER,” Filed on Nov. 11, 2016, the entire contents of which being expressly incorporated herein by reference.

### TECHNICAL FIELD

The disclosed subject matter relates to child strollers generally, and to jogging strollers that provide for increased cornering ability.

### BACKGROUND

Jogging strollers, or simply “joggers,” are almost always three-wheeled strollers with a fixed front wheel (vs. the swivel-type found on all-terrain strollers). Joggers often have a hand brake in addition to a foot-operated parking brake. This, along with large, air-filled tires, makes them more suited for running. Joggers often have three large fixed wheels, shocks, 5-point safety harnesses and drink holders for the child.

The jogger provides a more forgiving structure for operating on ground that cannot be ensured to be flat and smooth surfaces. The increased speed of jogging with a stroller also called for greater care in securing and padding a child therein, because surface imperfections have the potential for greater effect at the increased speed. Still further, the air-filled wheels are more forgiving when compared to small wheeled and hard-wheeled strollers that can skitter every which way on the path when encountering any surface irregularity.

However, whereas traditional four-wheeled strollers often have one or more wheels mounted on casters to facilitate turning, joggers are most often equipped with fixed axle wheels. Accordingly, significant turns require that the stroller be tipped back such that the front wheel is raised off the ground to achieve such turns. Such tipping and turning is challenging to complete while maintaining speed.

Accordingly, what is needed is a jogging type stroller that facilitates turning.

### SUMMARY

According to one embodiment, the present disclosure provides a stroller, comprising: a support frame including a handle; a pair of rear wheels coupled to the support frame; and a front wheel coupled to the support frame; wherein rotation of the handle in a first direction to cause turning of the stroller in the first direction causes the rear wheels and the front wheel to camber in the first direction and rotation of the handle in a second direction opposite the first direction to cause turning of the stroller in the second direction causes the rear wheels and the front wheel to camber in the second direction. In one aspect of this embodiment, the support frame further includes a front fork coupled to the front wheel and a pivot mechanism including a pair of rear struts coupled to the pair of rear wheels. In a variant of this aspect, the pivot mechanism further includes a mid frame and a channel member, the mid frame being pivotally connected to the pair of rear struts and pivotally connected to the channel member, the channel member being coupled to the handle for rotation with the handle, thereby causing rotation of the front fork and the front wheel. In a further variant, the channel member is movably coupled to the front fork by a suspension. In still a further variant, the mid frame includes a lower bar with an axial bore and a rear bar with an axial bore, the mid frame being pivotally connected to the channel member by bolts that pass through the axial bores, the bolts having a common longitudinal axis about which the mid frame can rotate relative to the channel member. In still another aspect of this embodiment, the mid frame includes a lower brace having outer sides and an upper brace, each of the rear struts being coupled to the upper brace and having a bearing that engages the outer sides of the lower brace. In a variant of this aspect, each rear strut includes a forward tube and a rear tube rotatably mounted to an upper hub at one end and to a lower hub at another end. In a further variant, each of the lower hubs includes an axle mount that couples to one of the rear wheels. In another aspect, the support frame further includes a seat support configured to support a seat for receiving an occupant of the stroller. In a variant of this aspect, the seat support includes a leg support that is rigidly connected to the front fork and to pivot mechanism and a body support hingedly coupled to the leg support and having a release mechanism which may be activated to permit the body support to pivot toward the leg support into a storage position. In another aspect, the handle includes an adjustable grip configured to rotate relative to an upper tubing of the handle and fixed in a desired position, and a brake actuator configured to be moved toward the adjustable grip to activate brakes coupled to the pair of rear wheels. In a variant of this aspect, the handle includes lower tubing coupled to the pivot mechanism, upper tubing coupled to an adjustable grip and a hinge mechanism coupled between the lower tubing and the upper tubing. In a further variant, the handle further includes a sleeve that is movably mounted to the handle and movable between a first position wherein the sleeve does not cover the hinge mechanism to permit operation of the hinge mechanism to permit the upper tubing to pivot relative to the lower tubing, and a second position wherein the sleeve substantially covers the hinge mechanism to prevent operation of the hinge mechanism.

In another embodiment, the present disclosure provides a stroller, comprising: a support frame including a handle coupled through a pivot mechanism to a front fork attached to a front wheel, a pair of struts rotatably coupled to the pivot mechanism at one end and rotatably coupled to a pair of rear wheels at another end; wherein rotation of the handle to turn the stroller causes the front wheel and the pair of rear wheels to camber in a direction of rotation of the handle. In one aspect of this embodiment, the pivot mechanism further includes a mid frame and a channel member, the mid frame being pivotally connected to the pair of struts and pivotally connected to the channel member, the channel member being coupled to the handle for rotation with the handle, thereby causing rotation of the front fork and the front wheel. In a variant of this aspect, the channel member is movably coupled to the front fork by a suspension. In another variant, the mid frame includes a lower bar with an axial bore and a rear bar with an axial bore, the mid frame being pivotally connected to the channel member by bolts that pass through the axial bores, the bolts having a common longitudinal axis about which the mid frame can rotate relative to the channel member. In still another variant, the mid frame includes a lower brace having outer sides and an upper brace, each of the struts being coupled to the upper brace and having a bearing that engages the outer sides of the lower brace to set a spacing between the rear wheels. In a further variant, each strut includes a forward tube and a rear tube rotatably mounted to an upper hub at the one end and to a lower hub at the other end. In still a further variant, each of the lower hubs includes an axle mount that couples to one of the rear wheels. In yet another aspect, the handle includes an adjustable grip configured to rotate relative to an upper tubing of the handle and fixed in a desired position, and a brake actuator configured to be moved toward the adjustable grip to activate brakes coupled to the pair of rear wheels. In still another aspect, the handle further includes at least one sleeve that is movable between a first position wherein the sleeve maintains the handle in a use position and a second position wherein the sleeve permits the handle to be folded into a storage position.

In yet another embodiment, the present disclosure provides a stroller, comprising: a handle for steering the stroller; a pivot mechanism to translate rotation of the handle into rotation of a front fork, thereby causing tilting of a top of a front wheel coupled to the front fork in a direction of rotation of the handle; and a pair of struts coupled between a corresponding pair of rear wheels and the pivot mechanism, the pivot mechanism translating rotation of the handle into rotation of the pair of struts to cause tops of the rear wheels to tilt in the direction of rotation of the handle.

### BRIEF DESCRIPTION OF THE DRAWINGS

Advantages and features of the embodiments of this disclosure will become more apparent from the following detailed description of exemplary embodiments when viewed in conjunction with the accompanying drawings, wherein:

FIG. 1 is a front perspective view of a steerable jogging stroller;

FIGS. 2A and 2B are front and rear perspective views of a frame of the stroller of FIG. 1;

FIGS. 3A-C are perspective views of the stroller frame of FIG. 2 in a folded configuration;

FIG. 4 is a front plan view of the stroller frame of FIG. 2;

FIG. 5 is a rear plan view of the stroller frame of FIG. 2;

FIG. 6 is front perspective view of the stroller frame of FIG. 2 in a turning maneuver;

FIG. 7 is a left side plan view of the stroller frame of FIG. 2;

FIG. 8 is a right side plan view of the stroller frame of FIG. 2;

FIG. 9 is a top plan view of the stroller frame of FIG. 2;

FIG. 10 is bottom plan view of the stroller frame of FIG. 2;

FIG. 11 is a bottom perspective view of the stroller frame of FIG. 2;

FIG. 12 is a front perspective view of a steering mechanism of the stroller frame of FIG. 2;

FIG. 13 is rear perspective view of the steering mechanism of the stroller frame of FIG. 2;

FIG. 14 is a cross sectional view of the steering mechanism of FIGS. 12 & 13; and

FIG. 15 is an exploded view of the steering mechanism of FIGS. 12 & 13;

FIG. 16 is a perspective view of a handle hinge of the stroller frame of FIG. 2;

FIG. 17 is a partially exploded view of the stroller of FIG. 2; and

FIG. 18 is a diagram showing relative movements of parts of the stroller of FIG. 2.

Corresponding reference characters indicate corresponding parts throughout the several views. Although the drawings represent embodiments of the present disclosure, the drawings are not necessarily to scale and certain features may be exaggerated in order to better illustrate and explain the present disclosure. The exemplifications set out herein illustrate embodiments of the disclosure, in one form, and such exemplifications are not to be construed as limiting the scope of the disclosure in any manner.

### DETAILED DESCRIPTION

In accordance with various embodiments of the disclosure, a jogging stroller 100 for transporting a child is disclosed.

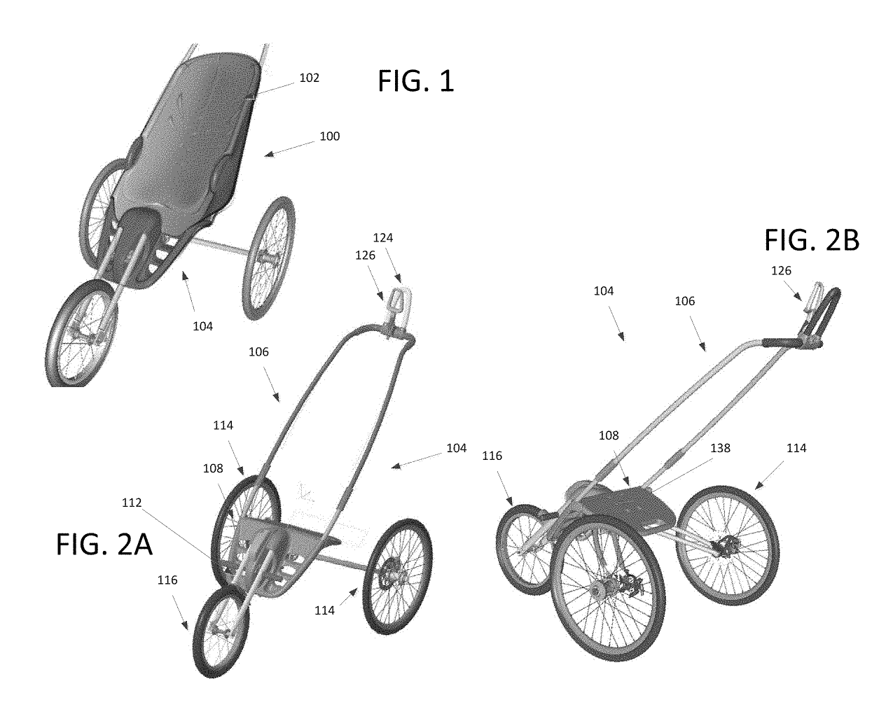

As shown in FIG. 1, stroller 100 includes seat 102 and support frame 104. Seat 102 is illustratively a cloth element that is supported by support frame 104 and that is sized and shaped to comfortably receive and secure a child therein. Support frame 104 is a plastic and metal mechanism that supports seat 102 on three wheels 114, 116.

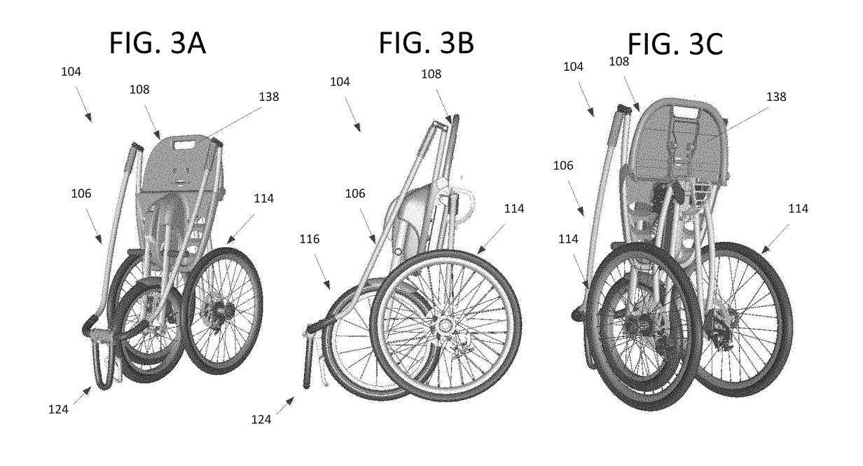

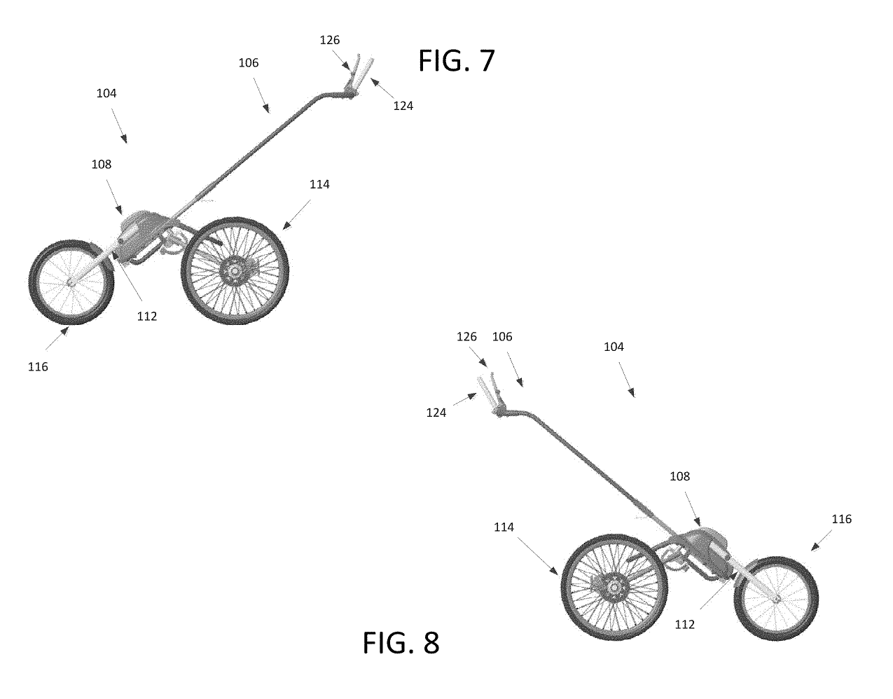

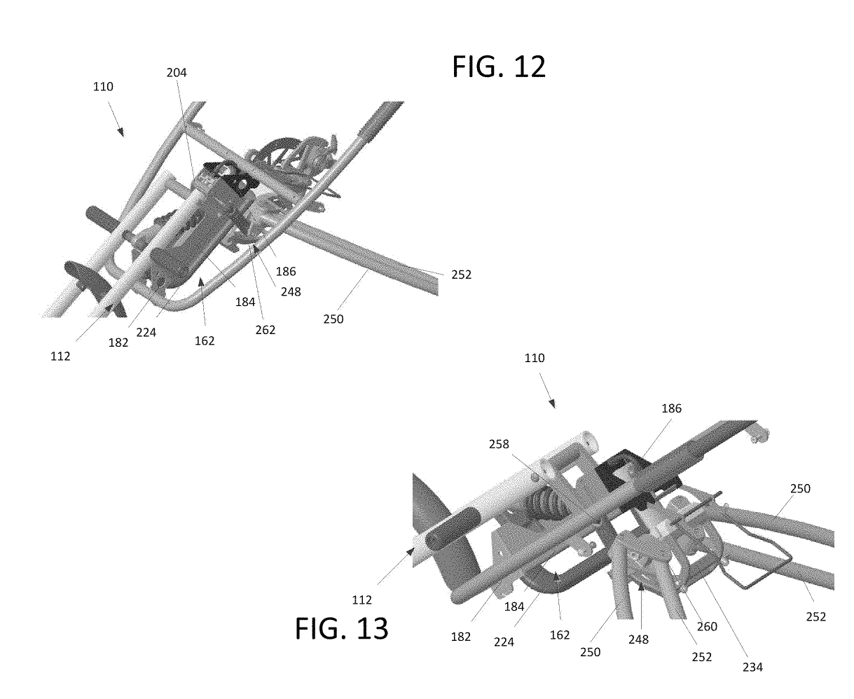

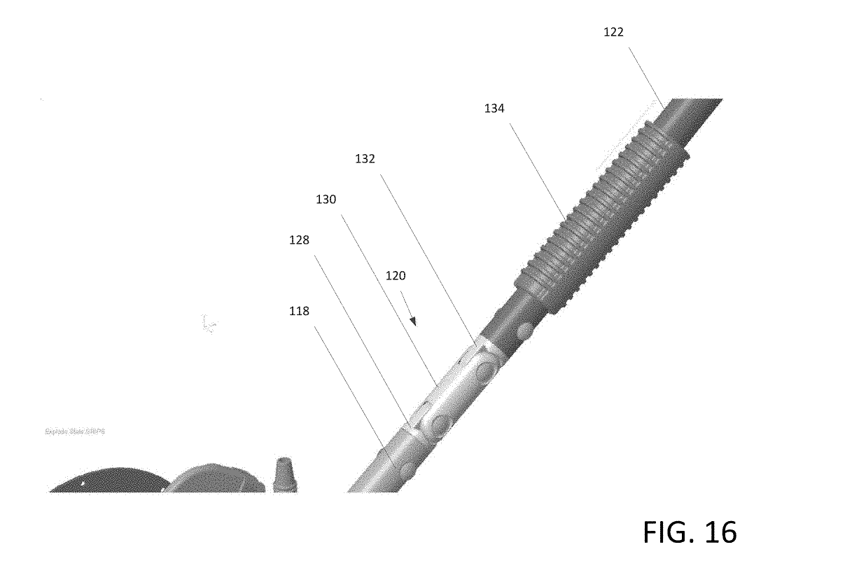

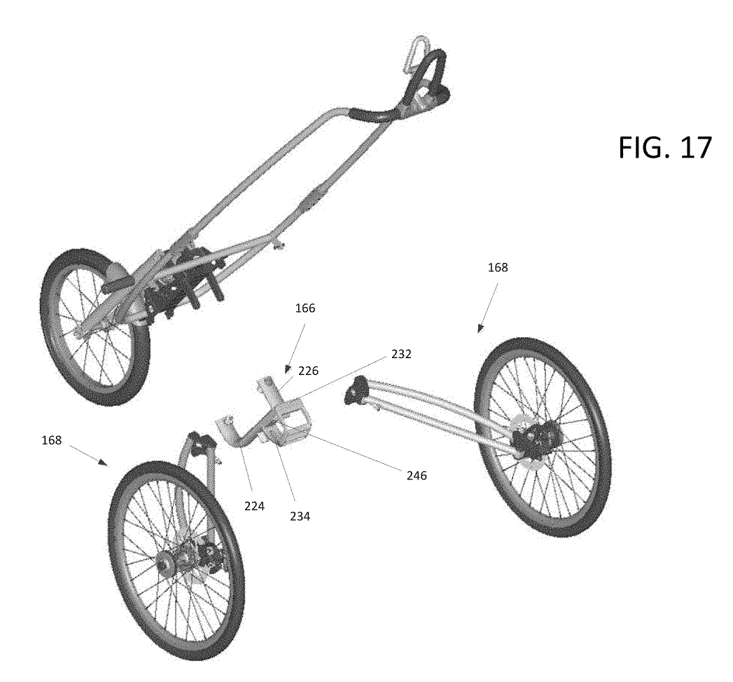

Support frame 104 includes handle 106, seat support 108, pivot mechanism 110 (FIGS. 12 and 13), front fork 112, rear wheels 114, and front wheel 116. As shown in FIGS. 7, 8 and 16, handle 106 includes lower tubing 118, hinge mechanism 120, upper tubing 122, adjustable grip 124, and brake actuator 126. Lower tubing 118 is coupled to upper tubing 122 via hinge mechanism 120. It should be appreciated that handle 106 includes two sides or legs that both include a hinge mechanism 120. Hinge mechanism 120 includes a lower end 128 that is at least partially received within lower tubing 118. Lower end 128 is further hingedly coupled to a middle portion 130. Middle portion 130 is further coupled to an upper end 132 that is at least partially received within upper tubing 122. Handle 106 further includes a sleeve 134 slidably located on upper tubing 122. Sleeve 134 is able to slide over upper tubing 122, hinge mechanism 120, and lower tubing 118. Sleeve 134 has a raised position (as shown in FIG. 16) in which it is clear of hinge mechanism 120. Hinge mechanism 120 provides two pivot points to allow handle 106 to fold back on itself as shown in FIGS. 3A-C when sleeve 134 is in the raised position, shown in FIGS. 16 and 3A-C. Sleeve 134 also includes a lowered position where portions of upper tubing 122, lower tubing 118 and hinge mechanism 120 are simultaneously located within a bore of sleeve 134. The lowered position of sleeve 134 requires that handle 106 be and remain in the un-folded position shown in FIGS. 2A-B. A user may push or pull on sleeve 134 to move sleeve 134 between the raised and lowered positions.

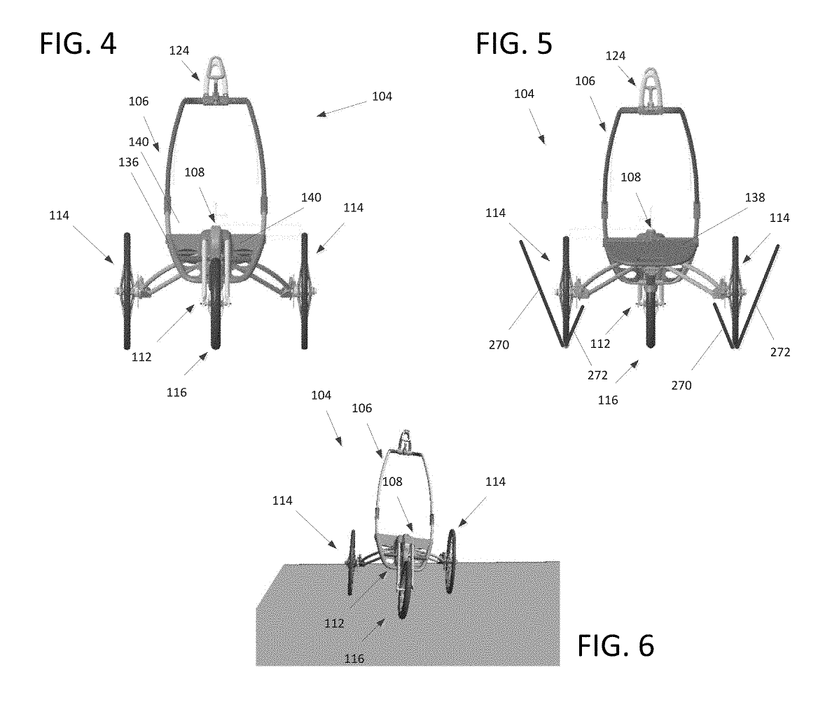

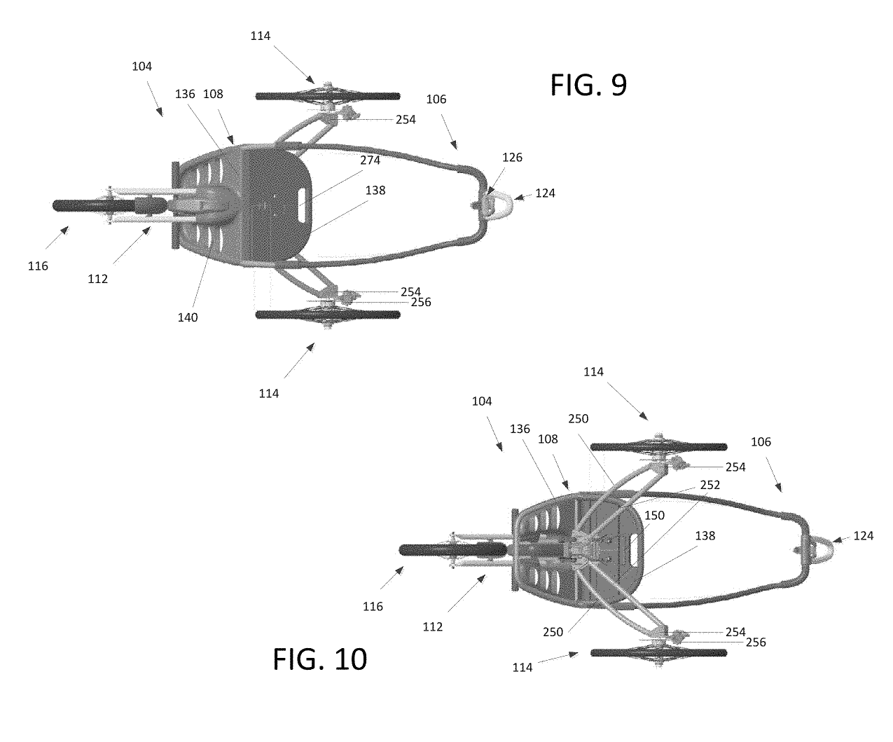

Adjustable grip 124 is an element attached to the proximal end of handle 106, as shown in FIGS. 4 and 5. Adjustable grip 124 is able to be oriented as desired by a user. Bolts of grip 124 can be loosened to allow adjustable grip 124 to rotate around upper tubing 122 until oriented as desired. Bolts of grip 124 are then tightened to fix the orientation of adjustable grip 124. Brake actuator 126 rotates with adjustable grip 124. Pulling or squeezing brake actuator 126 towards adjustable grip 124 causes a wire of one or more Bowden cables (not shown) to be pulled to activate brakes 256 as shown in FIGS. 9 and 10. It should be appreciated that the brake can be operated using a single hand and works equally well for either hand.

Now referring to FIGS. 9 and 10, seat support 108 includes leg support 136 and body support 138. Leg support 136 is illustratively fixed to front fork 112 and to pivot mechanism 110. Leg support 136 includes leg wells 140 to receive a child's legs and provides walls that shield a child from moving parts such as those of the pivot mechanism 110. The leg wells 140 are illustratively disposed on opposing lateral sides of the front fork 112.

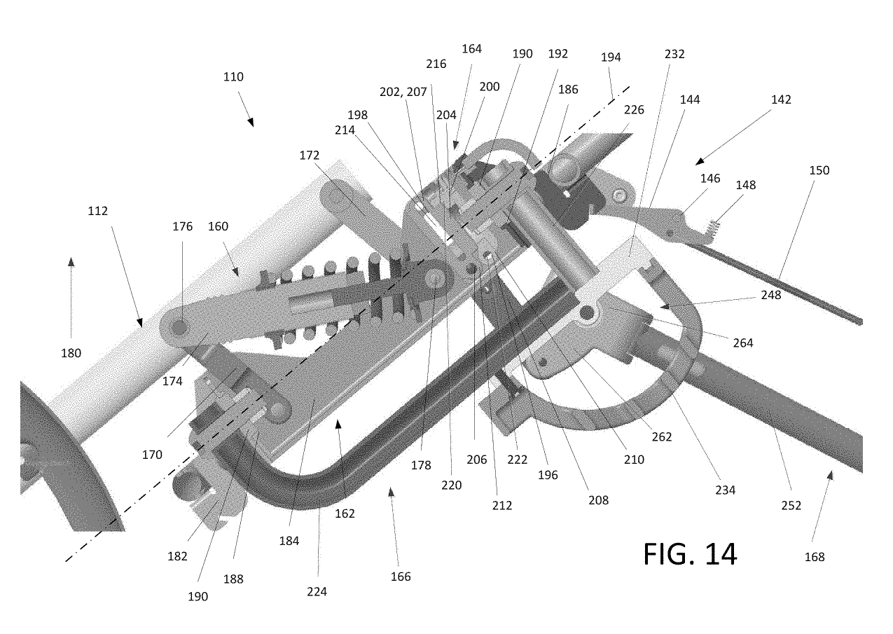

Body support 138 is hingedly coupled to leg support 136 and has a release mechanism 142 (FIG. 14) coupled to the bottom thereof. Release mechanism 142 includes latch 144, hinge pin 146, springs 148, handle 150, and a release wire (not shown). A lower side of body support 138 includes a number of molded elements sized, shaped, and positioned to receive a portion of hinge pin 146 and a portion of handle 150 therein to retain release mechanism thereon. Latch 144 is mounted on hinge pin 146 such that latch 144 is hingedly mounted to body support 138. Springs 148 are disposed on one end of latch 144 such that springs 148 are disposed between latch 144 and body support 138 to bias latch 144. Handle 150 is able to be pulled by a user to overcome the bias of springs 148 and rotate latch 144 about hinge pin 146. Body support 138 is able to rotate between a use position, shown in FIGS. 2A-B and a storage position shown in FIGS. 3A-C. Movement of body support 138 into the storage position also causes tension in the release wire (not shown). Release wire is illustratively a bowden cable. The release wire extends from body support 138 on one end to an interference member 200 on the other.

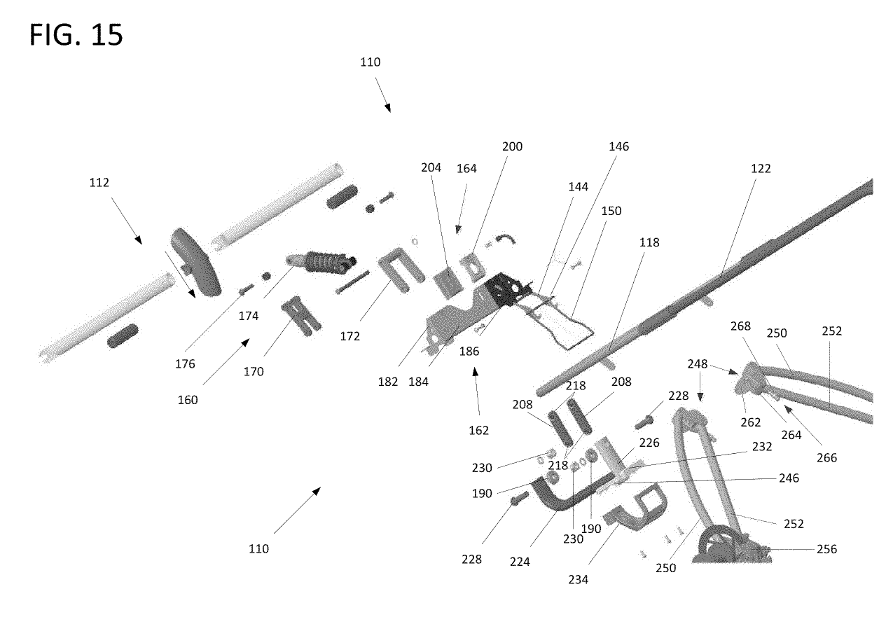

Pivot mechanism 110, shown assembled FIG. 14, includes a suspension 160, channel member 162, lock mechanism 164, mid frame 166, and rear struts 168. Suspension 160 includes front link 170, rear link 172, and shock 174, shown separately in FIG. 15. Each of front link 170, rear link 172, and shock 174 have an upper/forward end that hingedly mounts to front fork 112. Front link 170 is illustrated as having an “H” shape. The upper end of front link 170 includes a gap that is suitable to receive a portion of shock 174 therebetween. The lower end of front link 170 includes a gap that provides suitable clearance for axle bolts 228, discussed below. Rear link 172 is illustratively shaped as a “U” and includes a lower end having a gap between tines that provides for an end of shock 174 to be located therein.

Referring now to FIGS. 12-14, front link 170 and shock 174 mount to front fork 112 at a common axle 176. Rear link 172 mounts to front fork 112 at a location that is rearward from where front link 170 mounts to front fork 112. Rear link 172 and shock 174 mount to channel member 162 at a common axle 178. Front link 170 mounts to channel member 162 at a location forward from where rear link 172 mounts to channel member 162. Absent shock 174, the combination of front link 170, rear link 172, front fork 112 and channel member 162 form a four-bar linkage that allows front fork 112 to move relative to channel member 162. Shock 174 is mounted diagonally across the four-bar linkage and biases the position of the four-bar linkage. With respect to FIG. 14, the weight of the stroller generally and the engagement of front wheel 116 with the ground (transmitted through front fork 112) urges front fork in the direction of arrow 180. Shock 174 at least partially counteracts this force. Accordingly, in use, shock 174 is able to at least partially absorb quickly applied forces from the front wheel (such as due to hitting a bump or surface imperfection) to dampen the amount of such force transmitted to the channel member 162 (and the rest of the frame 104 and any occupant generally). The shock 174 likewise dampens forces received via rear wheels 114 and overall increases a likelihood of wheels 114, 116 maintaining contact with the ground when surface irregularities are encountered.

Channel member 162 includes a front handle mount 182, main channel 184, and rear handle mount 186. Front handle mount 182 is fixed to main channel 184, such as through welding. Rear handle mount 186 is also fixed to main channel 184, such as through welding. Front handle mount 182 is also mounted to handle 106, such as via rivets or otherwise. Rear handle mount 186 is also coupled to handle 106, such as by rivets or otherwise. As such, handle 106 and channel member 162 are in a fixed relationship. Front handle mount 182 further includes a bearing recess 188 that receives a ring bearing 190 therein. Similarly, rear handle mount 186 includes a bearing recess 192 that receives ring bearing 190 therein. Bearing recesses 188, 192 are co-axial such that when bolts 228, discussed below, are received therein, the bolts 228 are also co-axial (i.e., share axis 194, FIG. 14). Ring bearings 190 are illustratively constructed from steel ball bearings and races and are press-fit within recesses 188, 192. Ring bearings 190 include a portion having a diameter that fits within recesses 188, 192 and also include a portion of greater diameter that is unable to fit within recesses 188, 192. As further described below, the section of greater diameter acts to space bars 224, 226 away from handle mounts 182, 186. Main channel 184 includes a plurality of recesses defined in the lateral sides thereof. Each recess includes a counterpart recess on the opposite lateral side of main channel 184. As shown most clearly in FIG. 15, the recesses include a lower recess 196, a slot recess 198, and an upper recess 202.

Referring again to FIG. 14, lock mechanism 164 includes slider 204, interference member 200, link axle 206, slider axle 207, links 208, and interference hinge 210. Slider 204 is illustratively a plastic piece with an axle hole 212 and a slot 214 defined therein that both span the lateral width of slider 204. Slider 204 further includes a lock shoulder 216 disposed on a rear side thereof. Link axle 206 includes an axle rod and spherical hinges (ball joints) 218 (FIG. 15) at each end thereof. Link axle 206 passes through both slot recesses 198 of main channel 184 and axle hole 212 of slider 204. The spherical hinges 218 mount to links 208 and allow some degree of motion between link axle 206 and links 208 in all three dimensions. While axle hole 212 has a diameter that closely approximates the diameter of the rod of link axle 206, slot recesses 198 allow substantial travel of link axle 206 therein. Accordingly, slider 204 is able to slide relative to main channel 184. Slider axle 207 passes through upper recesses 202 of both lateral walls of main channel 184 and through slot 214 of slider. This relationship again allows slider 204 to slide relative to main channel 184. Having two axles 206, 207 provides that slider 204 is restricted to sliding in a straight path and maintaining a constant orientation as it slides. FIG. 14 shows slider 204 in a lowered and locked position.

Slider 204 is locked via engagement with interference member 200. Interference member 200 includes a lock surface 220 that abuts lock shoulder 216 when slider 204 is in the lowered position. The abutment of lock surface 220 and lock shoulder 216 prevents slider 204 from travelling out of the lowered position. Interference member 200 includes a bore 222 that is co-axial with lower recess 196 such that interference hinge 210 is able to be received in both bore 222 and lower recess 196. Interference hinge 210 thus provides a point of rotation for interference member 200. When release mechanism 142 is activated and body support 138 is rotated upward, a wire is pulled, and the upper end of interference member 200 is pulled and caused to rotate about interference hinge 210. Such rotation causes lock surface 220 to disengage from lock shoulder 216 and be pulled clear of lock shoulder 216. With such clearance, slider 204 is then able to slide relative to main channel 184. Interference member 200 is spring biased toward a position that causes lock surface 220 to engage lock shoulder 216. Thus, if the release wire is not being pulled and slider 204 returns to the lowered position, interference member 200 will snap back to cause lock surface 220 to engage lock shoulder 216 and thereby lock slider 204 in the lowered position. It should be appreciated that when slider 204 moves, links 208 are pulled along for similar motion.

Mid frame 166 (assembled and isolated in FIG. 17) includes a lower bar 224, rear bar 226, axle bolts 228, axle nuts 230, upper brace 232, and lower brace 234. Lower bar 224, rear bar 226 and upper brace 232 are fixed together, such as by welding or otherwise. Lower bar 224 is illustratively a bent rod that cooperates with rear bar 226 to define a gap between the ends thereof that is slightly larger than the length between ring bearings 190 when ring bearings 190 are mounted in channel member 162. The ends of lower bar 224 and rear bar 226 are parallel to each other. Both lower bar 224 and rear bar 226 include axle bores 236 (FIG. 14). Axle bores 236 are sized, shaped, and positioned to be co-axial with each other (along axis 194) and receive axle bolts 228 therein. Axle bolts 228 pass through respective axle bores 236 and ring bearings 190. Axle bolts 228 then engage axle nuts 230 to retain them. With such a connection, mid frame 166 is able to rotate relative to channel member 162 about axis 194. Upper brace 232 is coupled, such as by welding, to the bottom of lower bar 224 and rear bar 226. Upper brace 232 includes axle bores 246 on each lateral side (FIGS. 15 and 17). Lower brace 234 is coupled to upper brace 232, such as via bolts.

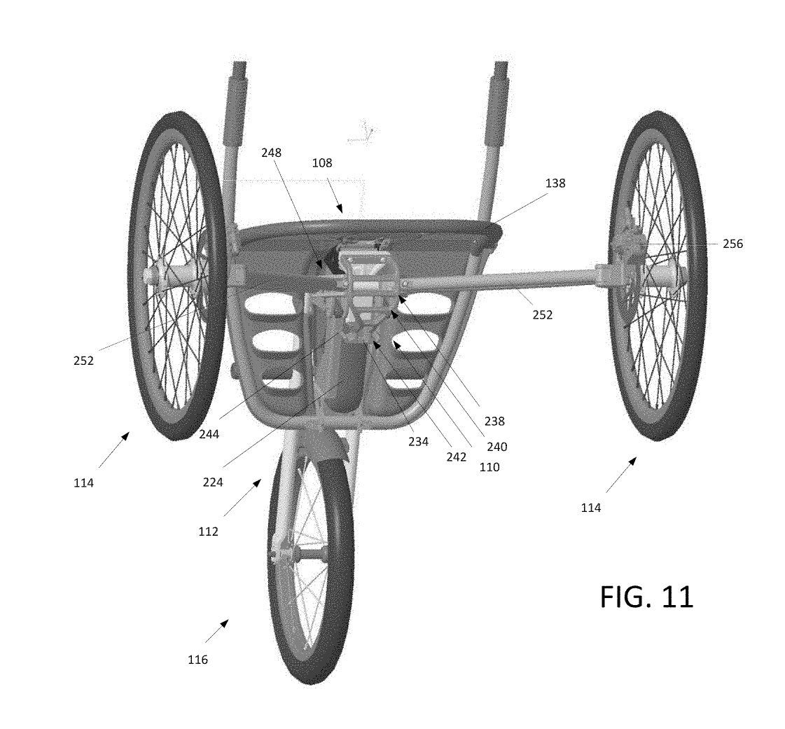

As best shown in FIG. 11, lower brace 234 includes sides that have a non-constant shape. Near a rear end, lower brace 234 includes a section 238 where outer sides are parallel. Moving forward on stroller 100, the next portion of lower brace 234 is a section 240 where the outer sides converge toward each other to present a narrowing between the outer lateral sides. Finally, the most forward part of lower brace 234 includes a section 242 of constant width. Section 242 also includes outer lips 244 as further described below. As will also be discussed below, the sides of lower brace 234 are sized and shaped to provide a track against which bearings 268 (FIG. 15) can roll as rear wheels 114 move back and forth from stowed positions to use positions.

Rear struts 168, shown most clearly in FIGS. 15 and 17, include right and left upper hubs 248, forward tubes 250, rear tubes 252, left and right lower hubs 254, and brakes 256. Upper hubs 248 include forward tube mounts 258, rear tube mounts 260, link mounts 262, and axle mounts 264. Forward tube mounts 258 receive forward tubes 250 and provide for rotational motion therebetween. The combination of forward tube mounts 258 and forward tubes 250 define a range of motion therebetween such that when rear struts 168 are in a use position, the weight of the stroller 100 causes a shoulder of forward tubes 250 to abut a wall of forward tube mount 258 to proscribe the use position. Rear tube mounts 260 receive rear tubes 252 and allow rotation therebetween. Link mounts 262 are provided as a “dog ear” portion that has a void defined therein to allow coupling to link 208 as shown in FIG. 14. Link mounts 262 couple to links 208 via a spherical or ball joint. Axle mounts 264 provide a spherical/ball joint that mount to axle bores 246 in upper brace 232.

Forward tubes 250, as noted above, couple at a front/upper end to upper hubs 248. Forward tubes 250 further includes a rear/lower end that mounts to lower hubs 254. Rear tubes 252 likewise include forward/upper ends coupled to upper hubs 248 and rear/lower ends coupled to lower hubs 254. Like forward tubes 250, rear tubes 252 are rotatably mounted to both upper hubs 248 and lower hubs 254. Rear tubes 252 further include a bearing assembly 266 on an inner/rear surface thereof. Each bearing assembly 266 includes a bearing 268 rotatably mounted on rear tube 252. Bearing 268 is located on rear tubes 252 such that bearing 268 rolls along lower brace 234 as upper hubs 248 (and rear struts 168 generally) rotate about axle mounts 264, as is further described below. Bearing 268 is further sized, shaped, and located such that bearing 268 fits within outer lips 244 of lower brace 234. When bearing 268 is adjacent outer lips 244, the lateral movement of bearing 268 (and thus forward and rear tubes 250, 252) is restricted.

Left and right lower hubs 254 mount to forward and rear tubes 250, 252 and support brakes 256. Lower hubs 254 further include axle mounts that couple to rear wheels 114. Left and right lower hubs 254 are rotatably mounted to forward and rear tubes 250, 252.

Overall, the components of stroller 100 cooperate to provide rear wheels that change their camber in response to the leaning of handle 106. FIG. 6 shows handle 106 leaned or rotated leftward (from a user's perspective). As can be seen, each of the wheels 114, 116 has a camber where the top of the wheel 114, 116 is more leftward. The front wheel 116 and right rear wheel 114 have negative camber while the left rear wheel 114 is given positive camber. It should be appreciated that by leaning the camber in the direction of a turn, an increased amount of centrifugal force is directed in the plane of the tire relative to perpendicular to the plane of the tire such that 1) increased force is provided for grip of the tire and 2) less force is provided that would urge a tire move laterally (shear). Overall, camber provides aid in turning a vehicle. FIG. 5 illustratively shows planes 270, 272 that can be assumed by the plane of wheels 114. In one embodiment, wheels 114, 116 can tilt up to 15-degrees. The amount of tilt or camber proscribes a natural turn radius. A greater tilt provides a “tighter” or smaller natural turning radius.

Referring now to FIGS. 12 and 13, the operation of pivot mechanism 110 to produce changes in camber is discussed. A user interacts with pivot mechanism 110 by using handle 106 as an input. As previously discussed, handle 106 is fixed to front handle mount 182 and rear handle mount 186. Accordingly, leftward or rightward rotational movement of handle 106 is communicated to cause a rotation of front handle mount 182, main channel 184, and rear handle mount 186 about axis 194 (FIG. 14). Such resulting rotation causes similar rotation of front fork 112 and thus wheel 116. Mid frame 166 is supported by rear wheels 114 and is rotatable relative to front handle mount 182, main channel 184, and rear handle mount 186. Thus, at the outset, a force that operates to rotate front handle mount 182, main channel 184, and rear handle mount 186 operates to rotate these elements relative to mid frame 166.

During a left turn (shown in FIG. 6), front handle mount 182, main channel 184, and rear handle mount 186 rotate counter-clock wise (from the perspective of the user). Such movement causes left link 208 to lower (rotating left wheel 114 upwardly) and right link 208 to raise (rotating right wheel 114 downwardly). Lowering left link 208 urges left upper hub 248 to rotate counter-clockwise (when looking at stroller 100 from the left side). This counter-clockwise movement of left upper hub 248 around axle mounts 264 alters the relative vertical positions of forward tube mount 258 and rear tube mount 260. Such alteration translates through forward tubes 250 and rear tubes 252 to left lower hub 254 and wheel 114. This movement also induces a “lean” to the stroller 100 as the left upper hub 248 is then lower than right upper hub 248. Such a lean causes forward tube mount 258 of left upper hub 248 to be further left than rear tube mount 260. This translates to a similar orientation for left lower hub 254 which alters the axle axis for the left wheel 114. Accordingly, camber is introduced to the left wheel 114.

Similarly, during the left turn, raising right link 208 urges right upper hub 248 to rotate clockwise (when looking at stroller 100 from the left side). Referring to FIG. 14 which is a view from the left, during a left turn link 208 moves upwardly and to the left, which pulls up on link mount 262 of upper hub 248, thereby causing upper hub 248 to rotate clockwise. This clockwise movement of right upper hub 248 around axle mounts 264 alters the relative vertical positions of forward tube mount 258 and rear tube mount 260. Such alteration translates through forward tubes 250 and rear tubes 252 to right lower hub 254 and the right rear wheel 114. This movement also induces a “lean” to the stroller 100 as the right upper hub 248 is then higher. The lean causes forward tube mount 258 of right upper hub 248 to move left relative to rear tube mount 260. This translates to a similar orientation for right lower hub 254 which alters the axle axis for the right wheel 114. Accordingly, camber is introduced to the right wheel 114 as well as the left wheel 114. It should be appreciated that pivot mechanism 110 introduces a similar camber for both wheels 114 such that the wheels are always substantially parallel. Still further the camber for rear wheels 114 approximates the camber of front wheel 116.

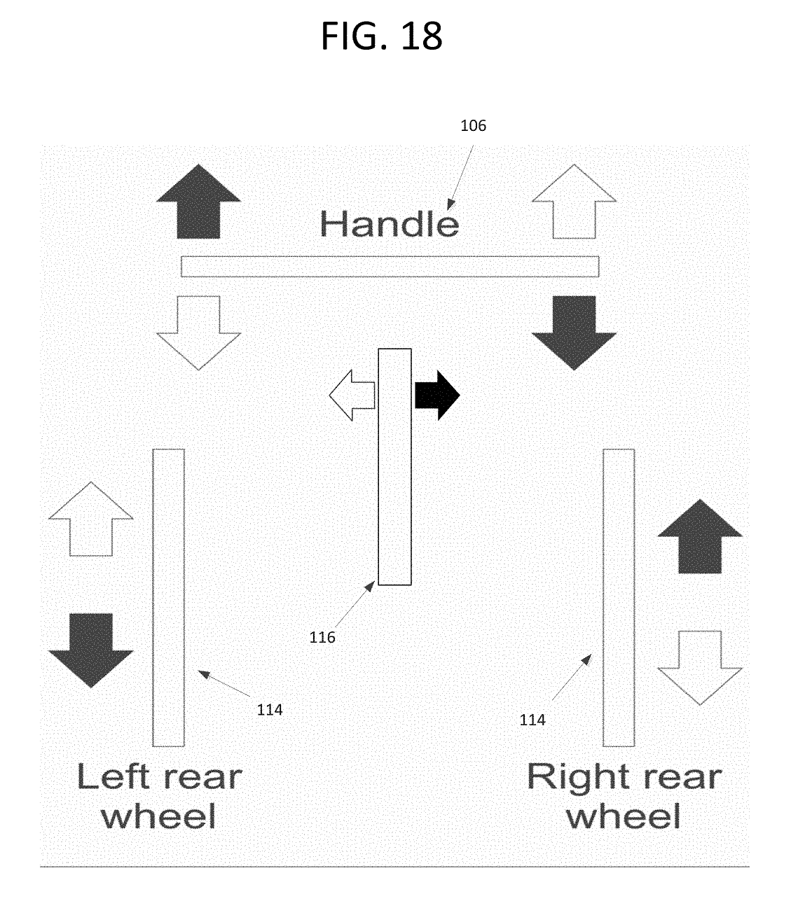

In general, FIG. 18 shows a representation of relative movement (from the perspective of the user) of the various parts (handle 106, right and left wheels 114). Movement of handle 106 such that the right side of handle 106 is lowered relative to the left side of handle 106, black arrows, is met with a relative raising of right rear wheel 114 and a relative lowering of left rear wheel 114. Accordingly, stroller 100 leans right. Similarly, movement of handle 106 such that the left side of handle 106 is lowered relative to the right side of handle 106, white arrows, is met with a relative raising of left rear wheel 114 and a relative lowering of right rear wheel 114. Accordingly, stroller 100 leans to the left.

In addition to the use position, stroller 100 also has a folded configuration shown in FIGS. 3A-C. To place stroller 100 in the folded configuration, a user first reaches under body support 138 and grips handle 150. When handle 150 is pulled rearwardly, latch 144 rotates to disengage from rear handle mount 186 (see FIG. 14). With latch 144 disengaged, a user is able to lift up on body support 138. Body support 138 then rotates relative to leg support 136. As previously noted, this movement of body support 138 pulls on the release wire and causes interference member 200 to rotate out of engagement with lock shoulder 216 and slider 204 generally. A user then continues to raise body support 138 by continuing to grasp it via its handle bore 274 (FIGS. 3A and 3C). At some point, the raising of stroller 100 pulls pivot mechanism 110 away from the ground (either through a motion that raises all of stroller 100 or through a motion that raises pivot mechanism 110 and hinges about wheels 116, 114 that may remain on the ground). Such raising motion, if the stroller 100 was still in the locked position (lock shoulder 216 engaged with interference member 200) would pull rear wheels 114 off the ground. With the stroller unlocked, the weight of wheels 114 and rear struts 168 instead causes wheels 114 to remain on the ground and urges rotation of rear struts 168 about axle mounts 264. This rotation is possible in that rotation of upper hubs 248 urges links 208, and thus slider 204, upwards. With slider 204 unlocked, slider 204 is able to slide upwards as link axle 206 slides within slot recess 198. The rotation of rear struts 168 causes bearing 268 to roll along lower brace 234. As previously noted, as lower brace 234 extends forward, the distance between the sides thereof narrows. Accordingly, as bearing 268 travel forward (via rotation of rear struts 168, they encounter a more narrow portion of lower brace 234. Thus, wheels 114 are able to come closer together, laterally. This rotation, causing forward and inward movement of rear struts 168 continues until bearing 268 are located within outer lips 244. This location presents an end of travel location for bearings 268. Still further, outer lips 244 present laterally outward walls that prevent the respective bearing 268 and thus wheels 114 from loosely hinging outward about upper hubs 248. Thus, rear struts 168 are held in the more compact and “folded” orientation. Handle 106 can then be folded down by sliding sleeve 134 upwardly to expose hinge mechanism 120.

In reverse, handle 106 can be unfolded and re-locked in a use position. Stroller 110 can be leaned backwards to cause bearings 268 to roll rearward and out of outer lips 244. As bearings 268 follow the lateral surface of lower brace 234, they will widen the stance of rear struts 168. Such movement causes upper hubs 248 to rotate and pull downward on links 208. Links 208 thus pull downward on slider 204. Once slider 204 is fully moved down into the lowered position, the spring bias of interference member 200 pushes interference member 200 into engagement with slider 204 such that lock shoulder 216 engages interference member 200. Body support 138 is then rotated backwards and down until latch 144 engages rear handle mount 186 and latches therein.

In operation, stroller 100 leans to the right and left such that the plane of wheels 114, 116 offsets from vertical by up to 15 degrees, as previously noted. This offset provides a natural turning radius of approximately 19 ft (5.8 m). An offset of 5 degrees tilt provides a turning radius of 44 ft (13.4 m). It should be appreciated that such a range of turning radii is sufficient to handle curves in most purpose built running tracks and paths.

It should be further understood that the weight of stroller 100 is distributed such that the stroller 100 itself (and the stroller with a child when so occupied) provides a biasing force that urges stroller 100 to a position in which wheels 114, 116 are generally vertical (a “centered position”). Thus, on flat ground, absent outside forces, stroller 100 assumes a position where handle 106 is centered between rear wheels 114 and wheels 114, 116 are vertical. In certain embodiments, springs or other self-centering mechanisms are provided that provide additional biasing of stroller 100 to the centered position.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. § 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A stroller, comprising:
a support frame including a handle;
a pair of rear wheels coupled to the support frame; and
a front wheel coupled to the support frame;
wherein rotation of the handle in a first direction to cause turning of the stroller in the first direction causes the rear wheels and the front wheel to camber in the first direction and rotation of the handle in a second direction opposite the first direction to cause turning of the stroller in the second direction causes the rear wheels and the front wheel to camber in the second direction.

2. The stroller of claim 1, wherein the support frame further includes a front fork coupled to the front wheel and a pivot mechanism including a pair of rear struts coupled to the pair of rear wheels.

3. The stroller of claim 2, wherein the pivot mechanism further includes a mid frame and a channel member, the mid frame being pivotally connected to the pair of rear struts and pivotally connected to the channel member, the channel member being coupled to the handle for rotation with the handle, thereby causing rotation of the front fork and the front wheel.

4. The stroller of claim 3, wherein the channel member is movably coupled to the front fork by a suspension.

5. The stroller of claim 3, wherein the mid frame includes a lower bar with an axial bore and a rear bar with an axial bore, the mid frame being pivotally connected to the channel member by bolts that pass through the axial bores, the bolts having a common longitudinal axis about which the mid frame can rotate relative to the channel member.

6. The stroller of claim 2, wherein the mid frame includes a lower brace having outer sides and an upper brace, each of the rear struts being coupled to the upper brace and having a bearing that engages the outer sides of the lower brace.

7. The stroller of claim 6, wherein each rear strut includes a forward tube and a rear tube rotatably mounted to an upper hub at one end and to a lower hub at another end.

8. The stroller of claim 7, wherein each of the lower hubs includes an axle mount that couples to one of the rear wheels.

9. The stroller of claim 2, wherein the support frame further includes a seat support configured to support a seat for receiving an occupant of the stroller.

10. The stroller of claim 9, wherein the seat support includes a leg support that is rigidly connected to the front fork and to pivot mechanism and a body support hingedly coupled to the leg support and having a release mechanism which may be activated to permit the body support to pivot toward the leg support into a storage position.

11. The stroller of claim 1, wherein the handle includes an adjustable grip configured to rotate relative to an upper tubing of the handle and fixed in a desired position, and a brake actuator configured to be moved toward the adjustable grip to activate brakes coupled to the pair of rear wheels.

12. The stroller of claim 2, wherein the handle includes lower tubing coupled to the pivot mechanism, upper tubing coupled to an adjustable grip and a hinge mechanism coupled between the lower tubing and the upper tubing.

13. The stroller of claim 12, wherein the handle further includes a sleeve that is movably mounted to the handle and movable between a first position wherein the sleeve does not cover the hinge mechanism to permit operation of the hinge mechanism to permit the upper tubing to pivot relative to the lower tubing, and a second position wherein the sleeve substantially covers the hinge mechanism to prevent operation of the hinge mechanism.

14. A stroller, comprising:
a support frame including a handle coupled through a pivot mechanism to a front fork attached to a front wheel, a pair of struts rotatably coupled to the pivot mechanism at one end and rotatably coupled to a pair of rear wheels at another end;
wherein rotation of the handle to turn the stroller causes the front wheel and the pair of rear wheels to camber in a direction of rotation of the handle.

15. The stroller of claim 14, wherein the pivot mechanism further includes a mid frame and a channel member, the mid frame being pivotally connected to the pair of struts and pivotally connected to the channel member, the channel member being coupled to the handle for rotation with the handle, thereby causing rotation of the front fork and the front wheel.

16. The stroller of claim 15, wherein the channel member is movably coupled to the front fork by a suspension.

17. The stroller of claim 15, wherein the mid frame includes a lower bar with an axial bore and a rear bar with an axial bore, the mid frame being pivotally connected to the channel member by bolts that pass through the axial bores, the bolts having a common longitudinal axis about which the mid frame can rotate relative to the channel member.

18. The stroller of claim 15, wherein the mid frame includes a lower brace having outer sides and an upper brace, each of the struts being coupled to the upper brace and having a bearing that engages the outer sides of the lower brace to set a spacing between the rear wheels.

19. The stroller of claim 18, wherein each strut includes a forward tube and a rear tube rotatably mounted to an upper hub at the one end and to a lower hub at the other end.

20. The stroller of claim 19, wherein each of the lower hubs includes an axle mount that couples to one of the rear wheels.

21. The stroller of claim 14, wherein the handle includes an adjustable grip configured to rotate relative to an upper tubing of the handle and fixed in a desired position, and a brake actuator configured to be moved toward the adjustable grip to activate brakes coupled to the pair of rear wheels.

22. The stroller of claim 14, wherein the handle further includes at least one sleeve that is movable between a first position wherein the sleeve maintains the handle in a use position and a second position wherein the sleeve permits the handle to be folded into a storage position.

23. A stroller, comprising:
a handle for steering the stroller;
a pivot mechanism to translate rotation of the handle into rotation of a front fork, thereby causing tilting of a top of a front wheel coupled to the front fork in a direction of rotation of the handle; and
a pair of struts coupled between a corresponding pair of rear wheels and the pivot mechanism, the pivot mechanism translating rotation of the handle into rotation of the pair of struts to cause tops of the rear wheels to tilt in the direction of rotation of the handle.
